(19) United States
(12) Patent Application Publication
(10) Pub. No.: US 2003/0016680 A1
(43) Pub. Date: Jan. 23, 2003

(54) Broadband communication gateway capable of operating in differing environments

(75) Inventors: Robert C. Stein, Coopersburg, PA (US); David Lazarus, Elkins Park, PA (US)

Correspondence Address: VOLPE AND KOENIG, PC, DEPT MOT, SUITE 400, ONE PENN CENTER, 1617 JOHN F. KENNEDY BOULEVARD, PHILADELPHIA, PA, 19103, US

(73) Assignee: General Instrument Corporation, A Delaware Corporation, Horsham, PA

(21) Appl. No.: 09/908,320

(22) Filed: Jul. 17, 2001

(51) Int. Cl. H04L 12/28

(52) U.S. Cl. 370/401; 370/487

(57) ABSTRACT

A Communication Gateway is capable of operating in broadband telephony networks having different Cable Modem Termination System and Call Agent implementations. The Communication Gateway has a set of parameters for use in defining the different implementations. Based on a selected implementation of the different implementations, values for parameters of the set are input into the Communication Gateway. The inputted values are stored. The Communication Gateway operates in the selected implementation using the stored values.

### BACKGROUND

The invention generally relates to broadband communication systems. In particular, the invention relates to communication gateways in broadband communication systems.

FIG. 1 illustrates a communication network 10. Each network user has a Communication Gateway (CG) 14₁, to 14ₘ (14), as shown in FIG. 1. The CGs 14 interface user equipment, such as telephones 12₁, to 12ₙ (12) and computer modems, with the rest of the network. The CGs 14 are connected to an internet protocol (IP) network through a Cable Modem Termination System 16 (CMTS).

To handle the overhead functions of the IP network 18, a network management system 22, an operating support system 24 and a call management system 20 are used. The Call Management System 20, “Call Agent”, controls telephony calls sent through the network 18.

The IP network 18 transfers upstream packets of data in mini-slots 66₁ to 66ₘ (66) as shown in FIG. 2. The upstream communication spectrum is divided into repeating frames 64₁ to 64ₙ (64). Each frame 64 has a fixed number, n, of equal sized mini-slots 66.

The IP network is connected to the public switched telephone network (PSTN) 28 via an IP network/PSTN gateway 26. The IP/PSTN gateway 26 acts as the interface between the IP network 18 and the PSTN 28 or other networks.

The simplified hardware of a CG 14 is shown in FIG. 3. The CG 14 has an RF connector 32 to receive RF signals from and transmit RF signals over the network 10. A tuner/amplifier 34 and a cable modem 36 are used to convert the received RF signals into digital baseband signals and digital baseband signals into RF signals for transmission. The CG 14 also has a digital signal processor (DSP) 38 and codes 40 for processing voice signals. A processor 42 along with a random access memory (RAM) 44 and non-volatile memory (NVMem) 46 are used to perform various functions of the CG 14.

The simplified hardware of a Call Management System 20 is shown in FIG. 4. The Call Management System 20 comprises a Call Agent and a RF connector 48. The Call Agent 48 controls various functions of the Call Management System 20 and interacts with other modules 22,24. Call signaling 50 sends commands to control components of the network, such as the CGs 14. Other components of the Call Management System 20 for use in performing its functions are the communications stacks 52, network interface module (NIM) 54, processor 58, RAM 60, NVMem 62 and permanent storage 56.

As broadband networks have evolved, several different protocols have developed for the network implementation. To illustrate, CMTS manufacturers have developed their CMTS based on various versions of the DOCSIS specification (such as versions 1.0 and 1.1). Call Agent manufacturers have based their implementations on the various Packet Cable call signaling specifications, such as versions of Simple Gateway Control Protocol (SGCP), Media Gateway Control Protocol (MGCP) and network call signaling (NCS).

Accordingly, it is desirable to have communication gateways compatible with various broadband network implementations.

### SUMMARY

A Communication Gateway is capable of operating in broadband telephony networks having different Cable Modem Termination System and Call Agent implementations. The Communication Gateway has a set of parameters for use in defining the different implementations. Based on a selected implementation of the different implementations, values for parameters of the set are input into the Communication Gateway. The inputted values are stored. The Communication Gateway operates in the selected implementation using the stored values.

### BRIEF DESCRIPTION OF THE DRAWING(S)

FIG. 1 is a simplified illustration of a communication network.

FIG. 2 is an illustration of repeating frames and mini-slots.

FIG. 3 is a simplified illustration of a Communication Gateway.

FIG. 4 is a simplified illustration of a Call Management System.

FIG. 5 is a flow chart for initializing a Communication Gateway capable of working with different Cable Modem Termination System and Call Agent implementations.

FIG. 6 is a preferred set of parameters.

FIG. 7 is a table listing the parameter values for three implementations.

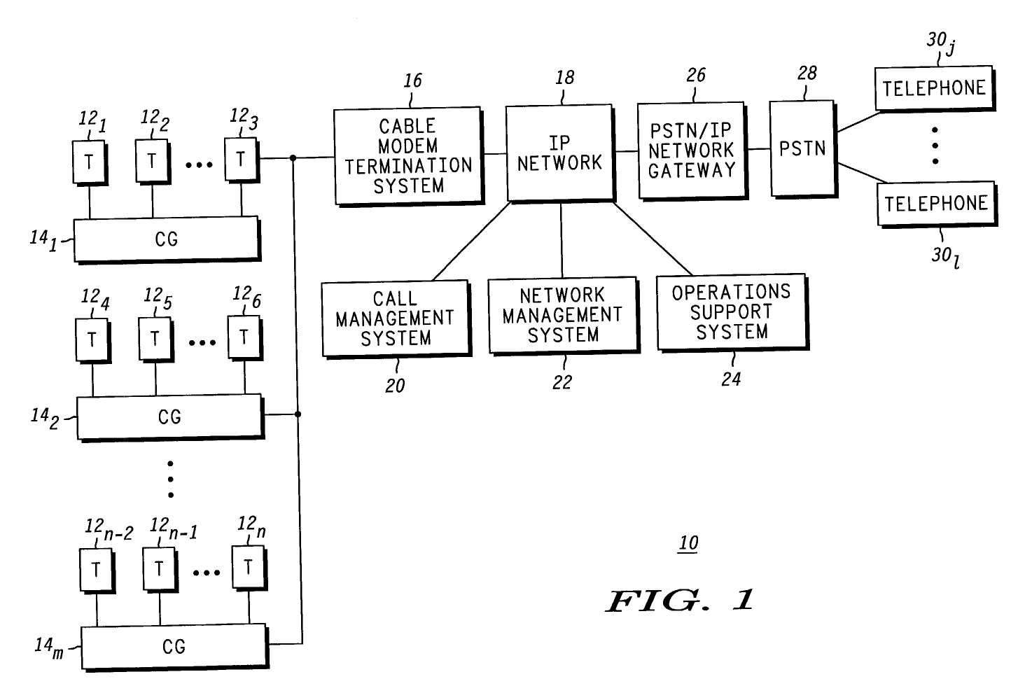

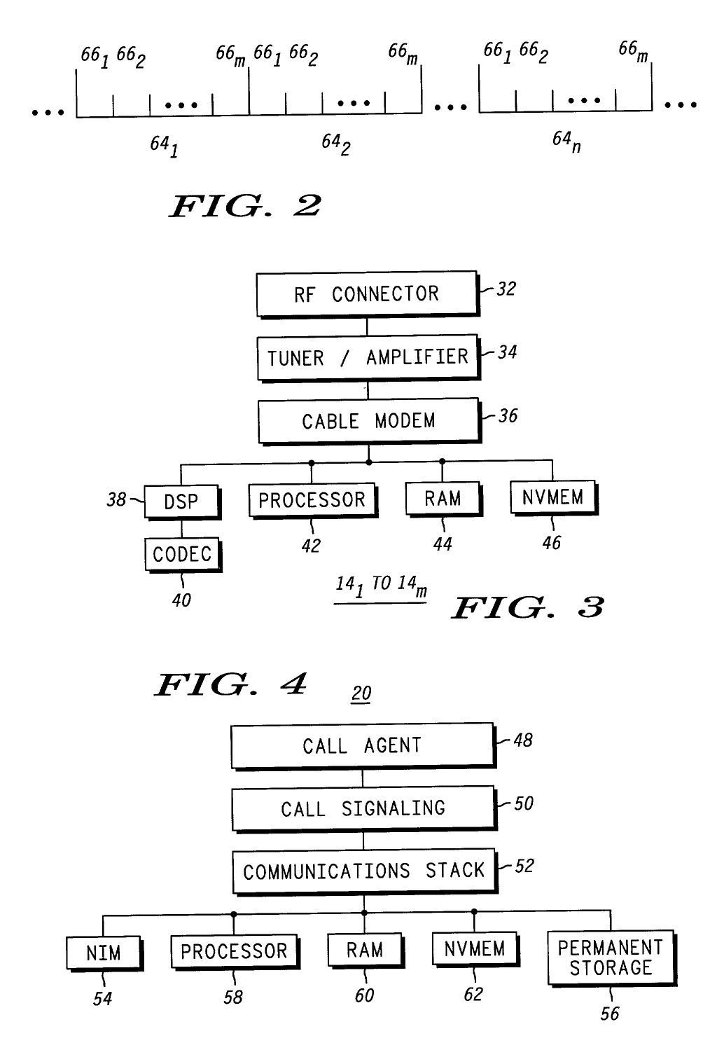

### DETAILED DESCRIPTION OF THE PREFERRED EMBODIMENT(S)

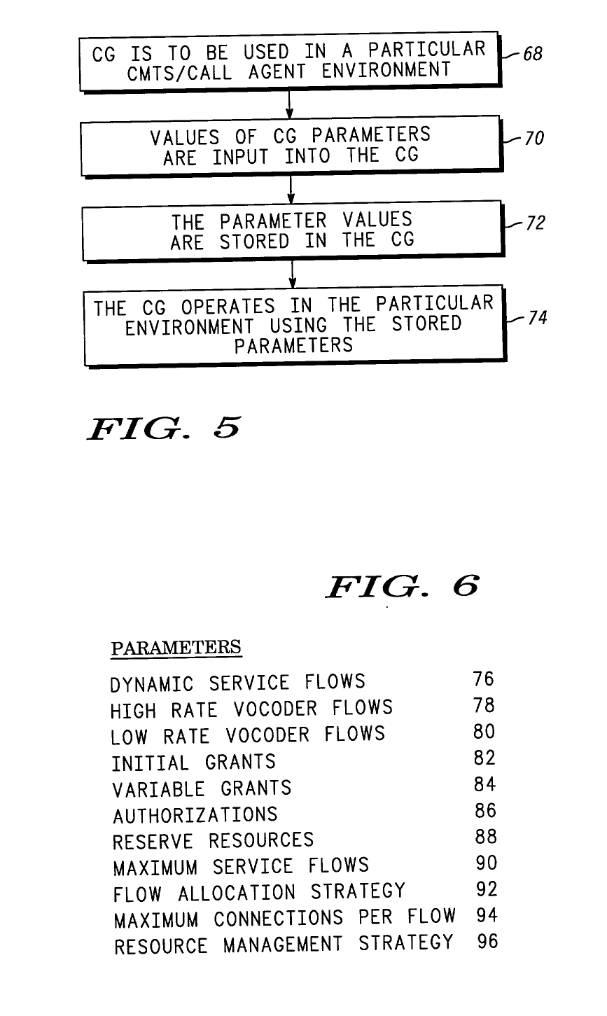

FIG. 5 is a flow chart for initializing a CG 14 capable of working with different CMTS and Call Agent implementations. The CG 14 uses a set of parameters which are used to define different CMTS and Call Agent environments. A CG 14 is to be set up in a particular CMTS and Call Agent environment (68). Values for the parameters of the set are input into the CG (70). The parameters may be input by a technician installing the unit, such as via a port or a lead. The parameters also may be remotely sent to the CG 14, such as using RF signals received via the RF connector 32. The parameter values are stored in a memory of the CG 14, such as the NVMem 46 (72). Using the input parameter values, the CG 14 is initialized to operate in the desired environment (74).

Parameters are used to define constraints the environment places on the CG 14. These parameters include the number of service flows and connections supported by the environment, the number of high and low rate vocoder flows, and the grants to initially allocate for a service. The parameters also indicate certain characteristics of the environment: whether changing a number of grants or service flows is supported, and whether bandwidth authorization is required, and flow allocation and resource management strategies. FIG. 6 illustrates a preferred list of parameters for use in allowing the CG 14 to operate in different environments.

The parameter, Dynamic Service Flows 76, indicates whether the environment supports changing the number of service flows during operation. The parameter is preferably a boolean value. If the value is “true,” a change in the number of service flows is supported. Initially, the number of service flows is set to zero. The CG 14 can add and delete service flows using Dynamic Service Addition Request (DSA-REQ) and Dynamic Service Deletion Request (DSD-REQ) commands to the CMTS 16. The number of added service flows is limited to not exceed a limit, such as a value for Maximum Service Flows 96. If the value is “false,” a change in the number of service flows is not permitted. At initialization, the number of service flows allocated is set to the maximum number potentially required, such as effectively to the value for Maximum Service Flows 96. To effectively set to Maximum Service Flows 96, the CG assumes these service flows are available for creating the connection, although the service flow identifications (IDs) need to be configured.

The parameter, High Rate Vocoder Flows 78, such as G.711 connections, is used in defining the number of service flows for high rate vocoder connections. In an environment where the number of service flows allotted to the CG 14 is adaptable (such as Dynamic Service Flows 76 being “true”), the value of High Rate Service Flows 78 indicates the maximum number of high rate vocoder connections that can be allocated to the CG 14. The connections are typically allocated using DSA-REQ commands to the CMTS 16. In an environment where the number of service flows allocated to the CG 14 is fixed (such as Dynamic Service Flows 76 being “false”), the value indicates the number of provisioned or pre-provisioned high rate vocoder flows available to the CG 14. This value may include a range, such as “0-2.” The range allows for some environments to mix high and low-rate vocoders and other environments do not.

The parameter, Low Rate Vocoder Flows 80, is used in defining the number of low rate vocoder connections, such as a connection at a lower rate than G.711 connections. In an environment where the number of service flows allotted to the CG 14 is adaptable (such as Dynamic Service Flows 76 being “true”), the value of Low Rate Vocoder Flows 80 indicates the maximum number of low rate vocoder connections that can be allotted to the CG 14. The connections are typically allocated using DSA-REQ commands to the CMTS 16. In an environment where the number of service flows allocated to the CG 14 is fixed (such as Dynamic Service Flows 76 being “false”), the value indicates the number of provisioned or pre-provisioned high rate vocoder flows available to the CG 14.

The parameter, Initial Grants 82, is used in defining a number of grants reserved or committed upon addition of a service flow, such as by the CG 14 adding a service flow using a DSA-REQ command. The parameter is preferably a numeric value, indicating the number of grants to be added. When changes in the number of grants is supported (such as Variable Grants 84 being “true”), the value of this parameter is typically set to one. The number of grants can be adjusted by Dynamic Service Change Request (DSC-REQ) commands. When changes in the number of service flows is not supported (such as Dynamic Service Flows 76 being “false”), this parameter is set to the maximum number of grants potentially required for the service flow, such as Maximum Connections Per Flow 96. When the new service flow is added, all of the grants identified by the value of Initial Grants 82 are allocated. To illustrate, a service flow uses only one grant, but may potentially use three grants. In that case, Initial Grants 82 is set to three.

The parameter, Variable Grants 84, is used to define the CG's ability to change the number of grants per service flow during operation, such as by DSC-REQ commands. This parameter is preferably a boolean value. When the value of this parameter is “true,” a change in the number of grants is supported. Typically, DSC-REQ commands are used to increase or decrease the number of grants for the service flows. The number of added grants is limited to the maximum allowable connections, such as defined by Maximum Connections Per Flow 96. When the value of Variable Grants 84 is “false,” Initial Grants 82 is set to the maximum number of grants potentially required, such as to Maximum Connections Per Flow 96.

The parameter, Authorizations 86, indicates whether the CMTS 16 requires authorization commands to authorize bandwidth to the CG 14. This parameter is preferably a boolean value. When this parameter is “true,” the CG 14 requires Dynamic Quality of Service (DQOS) parameters for authorization in the Local Connection Options of create connection (CRCX) and modify connections (MDCX) commands from the Call Agent. The CG 14 includes the authorization block in DSA-REQ and DSC-REQ commands transmitted to the CMTS 16. When this parameter is “false,” the CG 14 ignores DQOS parameters for authorization. The CMTS 16 does not support authorization.

The parameter, Reserve Resources 88, indicates whether the CMTS 16 supports a one or two step process for reserving and committing resources. In a two step process, the resource is first reserved for the CG 14. When needed, the reserved resource is committed in a second step. For a one step process, the resource is immediately reserved and committed to the CG 14. Reserve Resources 88 is preferably a boolean value. When this parameter is “false,” a one-step reserve/commit resource allocation is used. The QOS-Parameter Set Type in the Local Connection Options of a CRCX or delete connection (DLCX) command is ignored by the CG 14. When the parameter is “true,” the two-step reserve/commit resource allocation is used. The two-step reserve/commit is performed under the control of the Call Agent 20 through the QOS Parameter Set Type in the Local Connection Options of a CRCX or DLCX command.

The parameter, Maximum Service Flows 90, indicates the maximum number of service flows available to the CG 14. This parameter is preferably numeric. When changing the number of allotted service flows is supported (such as by Dynamic Service Flows 76 being “true”), this parameter specifies the maximum number of service flows potentially allotted to the CG 14, such as by using DSA-REQ commands to the CMTS 16. When changing the number of service flows is not supported (such as by Dynamic Service Flows 76 being “false”), this parameter specifies the number of provisioned or pre-provisioned service flows available to the CG 14. The total number of high and low rate vocoder service flows cannot exceed the value of this parameter.

The parameter, Flow Allocation Strategy 92, identifies the manner that flows and grants are allocated. This parameter is preferably a text field. One version of this parameter uses two values, “Flow-Dominant” or “Grant-Dominant.” Another version uses a third value, “Concatenation Based.”

Flow-Dominant indicates that new service flows are added to support additional bandwidth prior to adding more grants to existing flows. The adding of new flows continues until all the available service flows are allocated. After all the service flows are allocated, grants are added to existing service flows compatible with the requested connection parameters. A Flow-Dominant approach tends to improve jitter performance and is highly desirable in configurations supporting four or more voice service flows.

Grant-Dominant indicates that grants are added to compatible service flows (if available) prior to allocating more service flows. A Grant-Dominant approach conserves the number of used service flows. This approach is desirable in configurations supporting fewer than four voice service flows.

Concatenation Based indicates that new calls are added to existing service flows with the same grant interval. The size of the grant is expanded without increasing the number of grants. A Concatenation Based allocation tends to reduce the overhead of additional calls by eliminating the preamble and guard bands. It also tends to reduce mini-slot fragmentation.

The parameter, Maximum Connections Per Flow 94, indicates the maximum number of connections for a service flow. The value of this parameter is, preferably, numeric. For implementations changing the number of connections per flow (such as by Variable Grants 84 being “true”), additional connections to a flow are limited to the value of Maximum Connections Per Flow.

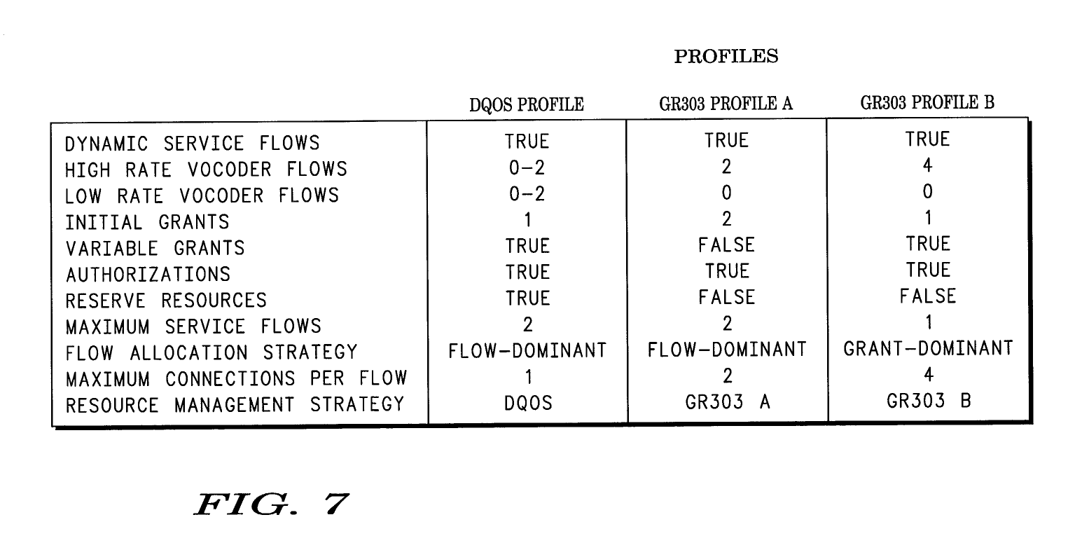

The parameter, Resource Management Strategy 96, is an optional parameter. It is, preferably, included for human convenience. Alternately, it may be used as shorthand for common network implementations. Resource Management Strategy represents the quality of service type (QOS-T) of the CG 14. The parameter is preferably a text field. This parameter indicates to an operator the upstream bandwidth telephony profile. Two examples of values for this parameter are “DQOS” and “GR-303” as shown in FIG. 7.

“DQOS” is shorthand for dynamic quality of service. It supports variable service flows (such as Dynamic Service Flows 76 being “true”) and variable grants (such as Variable Grants 84 being “true”). “DQOS” uses the two step resource allocation process (such as Reserve Resources being “true”).

“GR-303” is a resource management strategy similar to “DQOS.” “GR-303” uses variable service flows and variable grants. However, it uses a one step resource allocation process (such as Reserve Resources being “false”).

Alternately, this parameter is used as a shorthand for certain commonly used implementation profiles. In a table stored in the NVMem 46 of the CG 14, parameters are stored for certain common CMTS and Call Agent implementations. Using the shorthand value for Resource Management Strategy 96, the CG 14 looks up in the table the parameter values for the associated implementation.

FIG. 7 is an example of the values for three implementations using the preferred parameters. The implementations are a DQOS Profile, a GR-303 A Profile and a GR-303 B Profile.

What is claimed is:

1. A method for using a Communication Gateway in broadband telephony networks having different Cable Modem Termination System and Call Agent implementations, the method comprising:
providing the Communication Gateway, the Communication Gateway having a set of parameters for use in configuring the Communication Gateway to operate in the different implementations;
inputting into the Communication Gateway values for parameters of the set based on a selected implementation of the different implementations;
storing the inputted values; and
operating the Communication Gateway in the selected implementation using the stored values.

2. The method of claim 1 wherein the set of parameters are used by the Communication Gateway to configure a number of high, low rate vocoder flows, and initial grants to allocate a service supported by the implementation.

3. The method of claim 2 wherein the set of parameters are used by the Communication Gateway to configure whether dynamic service flows and variable grants are supported by the implementation.

4. The method of claim 3 wherein the set of parameters are used by the Communication Gateway to configure flow allocation and resource management strategies supported by the implementation.

5. A Communications Gateway capable of operating in broadband telephony networks having different Cable Modem Termination System and Call Agent implementations, the Communications Gateway comprising:
a memory having a set of parameters used for configuring the Communication Gateway to operate in the different implementations and storing values for the parameters received from an input;
the input for receiving values for the parameters and sending the values to the memory; and
a processor configuring the Communication Gateway to operate in an implementation using the stored values.

6. The Communication Gateway of claim 5 wherein the input is an RF connector.

7. The Communication Gateway of claim 5 wherein the input is a lead.

8. The Communication Gateway of claim 5 wherein the input is a port.

9. The Communication Gateway of claim 5 wherein the set of parameters are used by the Communication Gateway to configure a number of high, low rate vocoder flows, and initial grants to allocate a service supported by the implementation.

10. The Communication Gateway of claim 5 wherein the set of parameters are used by the Communication Gateway to configure whether dynamic service flows and variable grants are supported by the implementation.

11. The Communication Gateway of claim 5 wherein the set of parameters are used by the Communication Gateway to configure flow allocation and resource management strategies supported by the implementation.

12. A broadband communication system comprising:
a Cable Modem Termination System for interfacing between Communication Gateway and an internet protocol network;
a Call Agent for controlling telephony calls to and from the Communication Gateway; and
the Communication Gateway comprising:
means for storing a set of parameters for use in configuring the Communications Gateway to operate with differing Cable Modem Termination System and Call Agent implementations;
means for receiving values for parameters of the set based on a selected implementation of the Cable Modem Termination System and the Call Agent; and
means for operating the Communication Gateway in the selected implementation using the received values.

13. The system of claim 12 wherein the set of parameters are used by the Communication Gateway to configure a number of high, low rate vocoder flows, and initial grants to allocate a service supported by the implementation.

14. The system of claim 12 wherein the set of parameters are used by the Communication Gateway to configure whether dynamic service flows and variable grants are supported by the implementation.

15. The system of claim 12 wherein the set of parameters are used by the Communication Gateway to configure flow allocation and resource management strategies supported by the implementation.
